(19) United States
(12) Patent Application Publication
(10) Pub. No.: US 2024/0227431 A1
(43) Pub. Date: Jul. 11, 2024

(54) MICRO-CUT PATTERNED ARTICLE AND METHOD OF MAKING SAME

(71) Applicant: 3M INNOVATIVE PROPERTIES COMPANY, St. Paul, MN (US)

(72) Inventors: Raymond P. Johnston, Lake Elmo, MN (US); Kevin W. Gotrik, Hudson, WI (US); Graham M. Clarke, Woodbury, MN (US); John J. Sullivan, Hudson, WI (US); Matthew C. Messina, Maplewood, MN (US); Scott J. Jones, Woodbury, MN (US)

(21) Appl. No.: 18/559,097

(22) PCT Filed: Apr. 29, 2022
(86) PCT No.: PCT/IB2022/053999

§ 371 Date: Nov. 6, 2023

Related U.S. Application Data
(60) Provisional application No. 63/191,223, filed on May 20, 2021.

(51) Int. Cl. B44C 1/17

(52) U.S. Cl. CPC B44C 1/1737; B44C 1/1708; B44C 1/1729

(57) ABSTRACT

A patterned article includes a carrier layer having a microstructured first major surface and an opposing second major surface. The first major surface includes pluralities of upper and lower edges spaced apart along a thickness direction of the carrier layer and defining respective upper and lower portions of the first major surface. The lower portion is disposed between the upper portion and the second major surface. The article includes a first functional layer disposed on the lower, but not the upper portion of the first major surface. The first functional layer includes at least one first micro-cut inorganic layer including a plurality of cut edges substantially coextensive with the plurality of lower edges. A method of making the patterned article is provided. Articles that can be made by transferring a functional layer from the patterned article are provided.

### BACKGROUND

Sputtering is a high-precision vacuum deposition process that can deposit inorganic thin films with single digit nanometer thickness control across large areas, and can be suitable for roll-to-roll manufacturing. Sputtering can be used to deposit stacks of inorganic thin film layers such as, for example, metal layers and metal oxide layers, on a substrate. Materials, thicknesses and the order of arrangement of the thin film inorganic layers with different indices of refraction can be selected to fine-tune the aesthetic appearance and transmissive properties of an article.

### SUMMARY

The present description relates generally to patterned articles that include at least one micro-cut layer and to methods of making such patterned articles.

In some aspects of the present description, a patterned article is provided. The patterned article includes a carrier layer having a microstructured first major surface and an opposing second major surface. The first major surface includes pluralities of upper and lower edges spaced apart along a thickness direction of the carrier layer and defining respective upper and lower portions of the first major surface. The lower portion is disposed between the upper portion and the second major surface. The article includes a first functional layer disposed on the lower, but not the upper, portion of the first major surface. The first functional layer includes at least one first micro-cut inorganic layer including a plurality of cut edges substantially coextensive with the plurality of lower edges.

In some aspects of the present description, a method for making a patterned article is provided. The method includes providing a transfer article where the transfer article includes a carrier layer having opposing first and second major surfaces and includes a functional layer disposed on the first major surface: providing a tool including a plurality of microstructures where each microstructure includes at least one cutting edge: disposing the transfer article and the tool adjacent one another such that the functional layer faces the plurality of microstructures: and contacting the transfer article with the tool such that the tool embosses and cuts into the transfer article to form a pattern of cuts in the functional layer and to form a plurality of structures in the carrier layer defining upper and lower portions of the first major surface. The lower portion is disposed between the upper portion and the second major surface. A first portion of the functional layer is disposed on the upper portion of the first major surface and a second portion of the functional layer disposed on the lower portion of the first major surface. The first and second portions of the functional layer are separated from one another along the pattern of cuts.

In some aspects of the present description, a patterned article including a multilayer film is provided. The multilayer film includes a first polymeric layer; a functional layer including opposing first and second major surfaces where the first major surface disposed on the first polymeric layer; and a second polymeric layer disposed on the second major surface of the functional layer. The functional layer includes a multilayer stack including at least one micro-cut metal layer and at least one metal oxide or metal nitride layer. Each micro-cut metal layer has an average thickness in a range of 5 nanometers to 500 nanometers and includes a pattern of cuts forming either: (i) a pattern of discrete spaced apart plates corresponding to the pattern of cuts and bounded by the cuts with substantially no portion of the metal layer disposed between closest adjacent plates, or (ii) a continuous pattern corresponding to removing a pattern of discrete spaced apart plates corresponding to the pattern of cuts from the metal layer.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a carrier layer, according to some embodiments.

FIG. 2 is a schematic cross-sectional view of a patterned article including a functional layer, according to some embodiments.

FIGS. 3-4 are schematic cross-sectional views of patterned articles that include first and second functional layers, according to some embodiments.

FIG. 5A is a schematic cross-sectional view of another patterned article that includes first and second functional layers, according to some embodiments.

FIG. 5B is a schematic cross-sectional view of a patterned article corresponding to the patterned article of FIG. 5A where the second functional layer has been removed, according to some embodiments.

FIGS. 6-8 are schematic cross-sectional views of functional layers, according to some embodiments.

FIG. 9 is a schematic top plan view of a patterned functional layer illustrating a line edge roughness, according to some embodiments.

FIGS. 10A-10B are schematic cross-sectional views of patterned articles that include an overcoat, according to some embodiments.

FIGS. 11-13 are schematic top plan views of patterned articles that include first and second functional layers, according to some embodiments.

FIGS. 14-16 are schematic top plan views of patterned articles that include a functional layer, according to some embodiments.

FIG. 17 is a schematic cross-sectional view of a transfer article, according to some embodiments.

FIG. 18 is a schematic illustration of a method of making a patterned article, according to some embodiments.

FIG. 19 is a schematic cross-sectional view of a microstructure of a tool for making a patterned article, according to some embodiments.

FIG. 20 is a schematic cross-sectional view of a patterned article including a multilayer film, according to some embodiments.

FIG. 21 is schematic perspective view of an illustrative substrate having a curved surface.

FIG. 22 is schematic perspective view of patterned article including a multilayer film disposed on a substrate having a curved surface, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

In some aspects, the present description is generally directed to transfer articles including a dimensionally stable, yet flexible, transfer substrate having thereon a functional layer including at least one (e.g., very thin) inorganic layer. In some embodiments, the inorganic layer(s) in the functional layer of the transfer article are formed by a sputtering process and have a thickness of about 3 nanometers (nm) to about 2000 nm, for example. The transfer article containing the stable transfer substrate and at least one thin inorganic layer is subsequently contacted by a microstructured tool, according to some embodiments, to emboss the substrate and to form in the inorganic layer a pattern of cut edges faithfully corresponding to the pattern of the cutting edges of the tool. The precise pattern of cut edges may form an array of plates and a mesh pattern where the plates and the mesh pattern can be disposed in different planes.

In some embodiments, the patterned articles of the present description provide transferrable conductive layers with a thickness of less than about 3 micrometers, for example, which can be used as touch sensors or antennas for a wide range of applications such as 5G, for example, or other antenna applications utilizing frequencies in a range of 0.1 GHz to 300 GHz, for example. In some embodiments, the micro-cut inorganic layers provide a thin line conductive mesh material that can be manufactured without multiple post-plating steps. In some embodiments, the patterned article including the micro-cut inorganic layer, which can be diffusely reflective, is stretched in at least one dimension and applied to a non-planar or structured surface. The network of plates, for example, in the micro-cut inorganic layer may expand in varying amounts to accommodate the stretching and straining during the application process and conform to the surface. Once applied to the surface, the patterned article forms a micro-cut article with a precise arrangement of plates that are sufficiently small to provide tunable reflectivity performance with consistent color and a mirror-like aesthetic appearance at a selected viewing angle with respect to a major surface thereof.

Since the pattern of cut edges in the micro-cut inorganic layer can be a faithful reproduction of the pattern on the microstructured tool, the precise arrangement of plates make it possible to more accurately control the aesthetic appearance and/or conductivity of an article including stacks of inorganic materials when the article is stretched in one or more directions and applied on or adhesively bonded to a compound surface to form a laminate article. Micro-cutting the inorganic layer can also render the inorganic layer transmissive to electromagnetic signals within a desired frequency range, which can make the article useful in communication devices, for example.

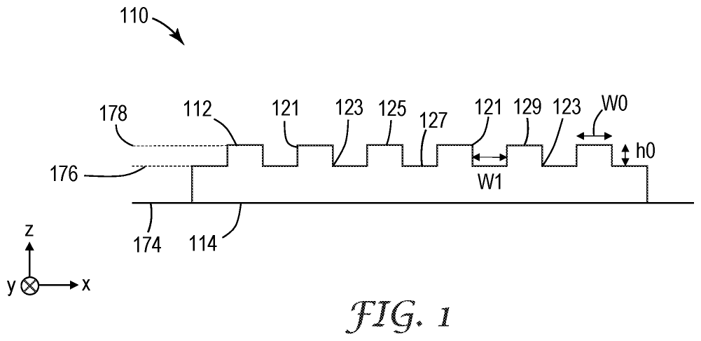

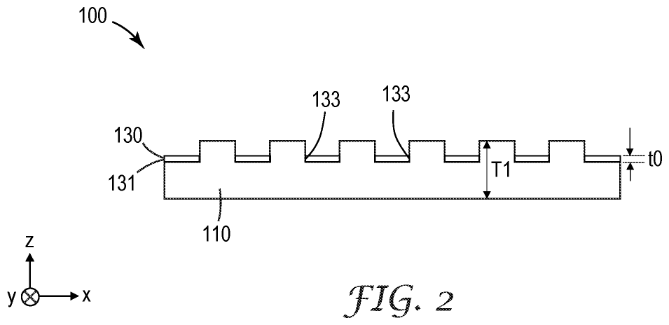

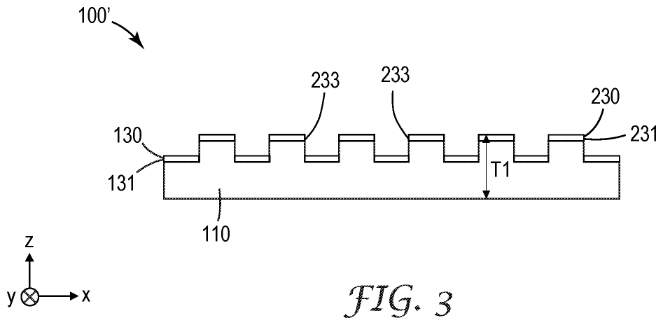

FIG. 1 is a schematic cross-sectional view of a carrier layer 110, according to some embodiments. FIGS. 2-3 are schematic cross-sectional views of patterned articles 100 and 100″, according to some embodiments. In some embodiments, a patterned article 100, 100′ includes a carrier layer 110 including a microstructured first major surface 112 and an opposing second major surface 114. The first major surface 112 includes pluralities of upper and lower edges 121 and 123 spaced apart along a thickness direction (z-direction referring to the illustrated x-y-z coordinate system) of the carrier layer 110 and defining respective upper and lower portions 125 and 127 of the first major surface 112, where the lower portion 127 is disposed between the upper portion 125 and the second major surface 114. In some embodiments, the upper and lower portions 125 and 127 are arranged in respective first and second regular patterns (e.g., a mesh pattern and a regular pattern of spaced apart plates, as described further elsewhere herein). The patterned article 100, 100′ includes a first functional layer 130 disposed on the lower (127), but not the upper (125), portion of the first major surface 112. The first functional layer 130 includes at least one first micro-cut inorganic layer 131 including a plurality of cut edges 133 substantially coextensive with the plurality of lower edges 123. The first functional layer 130 may be a single first micro-cut inorganic layer 131 or may include a plurality of layers as described further elsewhere herein.

In some embodiments, the patterned article 100′ further includes a second functional layer 230 disposed on the upper (125), but not the lower (127), portion of the first major surface 112, where the second functional layer 230 includes at least one second micro-cut inorganic layer 231 including a plurality of cut edges 233 substantially coextensive with the plurality of upper edges 121. The second functional layer 230 may be a single second micro-cut inorganic layer 231 or may include a plurality of layers as described further elsewhere herein.

In some embodiments, the cut edges 133 and/or 233 are disposed in a regular pattern (e.g., a regular pattern of straight line segments). In some embodiments, the cut edges 133 and/or 233 can have a linear shape, and can be arranged in a plurality of substantially parallel (e.g., with 20 degrees, or within 10 degree, or with 5 degrees of parallel) line segments (see, e.g., FIGS. 11-16) or in pluralities of substantially parallel first line segments (e.g., parallel to the x-direction of FIGS. 11-15) and substantially parallel second line segments (e.g., parallel to the y-direction of FIGS. 11-15) substantially orthogonal (e.g., with 20 degrees, or within 10 degree, or with 5 degrees of orthogonal) to the first line segments. In various embodiments, the cut edges 133, 233 (e.g., the total number of cut line segments of the first functional layer 130 and, when present, the second functional layer 230) are present on the first major surface 112 at about 0.3 to about 2000 per mm², or about 1 to about 1000 per mm², or about 10 to about 500 per mm², or about 20 to about 200 per mm², or about 50 to about 100 per mm².

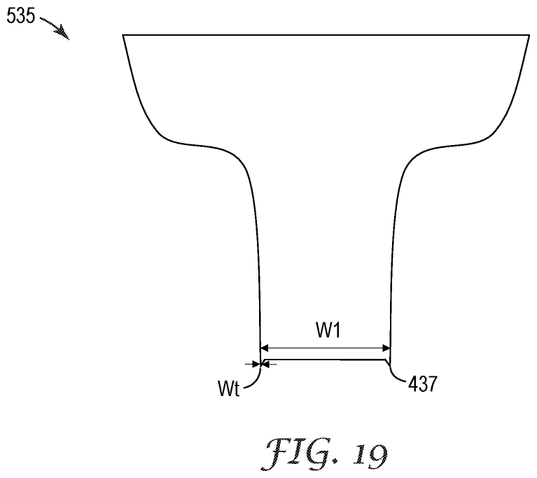

A microstructure is generally a structure having each of at least two orthogonal dimensions (e.g., a height and a width) in a range of about 0.1 micrometers to about 2000 micrometers. A micro-cut layer generally refers to a layer having cuts that defines elements of the layer having at least one dimension in a plane of the layer in a range of about 0.1 micrometers to about 2000 micrometers. A layer can be micro-cut using a tool having microstructures where each microstructure has at least one cutting edge. Such tools can be made using conventional micromachining processes (e.g., diamond cutting the microstructures into a cylindrical roll using a diamond cutting tool made by focused ion milling). Cutting tools for micromachining and methods of making such cutting tools are described in U.S. Pat. No. 7,140,812 (Bryan et al.) and U.S. Pat. No. 8,443,704 (Burke et al.), for example. Micro-cutting generally produces sharp cut edges that have a width (e.g., corresponding to the tip width Wt schematically illustrated in FIG. 19) substantially less (e.g., at least a factor of 2, or at least a factor of 4, or at least a factor of 8 less) than a smallest lateral dimension (e.g., the width W1 schematically illustrated in FIG. 19) of the elements formed by micro-cutting. Such cuts may be referred to as micro-cuts. For example, the cut edges 133 and/or the cut edges 233 can be micro-cut edges.

A functional layer including at least one micro-cut layer may be referred to as a micro-cut functional layer. In some embodiments, each layer of the functional layer 130 and 230 is a micro-cut layer having a substantially same pattern of cuts as the corresponding micro-cut inorganic layer.

A cut edge (e.g., cut edges 133 and 233) of a layer (e.g., inorganic layers 131 and 231) disposed on an upper (125) or lower (127) portion of the first major surface 112 may refer to an edge between a sidewall of the layer and the major surface of the layer facing the upper (125) or lower (127) portion of the first major surface 112. Alternatively, the cut edges of a layer may refer to side edges of the layer that extend between upper and lower major surfaces of the layer. A plurality of edges (e.g., 133, 233) can be described as substantially coextensive with another plurality of edges (e.g., 123, 121) when in a top plan view at least 60% of a total length of each plurality of edges extend along at least 60% of a total length of the other plurality of edges. In some embodiments, at least 70%, or at least 80%, or at least 90%, or at least 95% of a total length of each plurality of edges extend along at least 70%, or at least 80%, or at least 90%, or at least 95% of a total length of the other plurality of edges.

In various embodiments, a functional layer (e.g., functional layer 130 or 230) can include a stack of one or more layers selected to provide an article including the functional layer with some functional property including, for example, electromagnetic properties which may include, for example, electrical conductivity properties or reflective or transmissive properties, aesthetic properties, environmental properties, or antimicrobial properties.

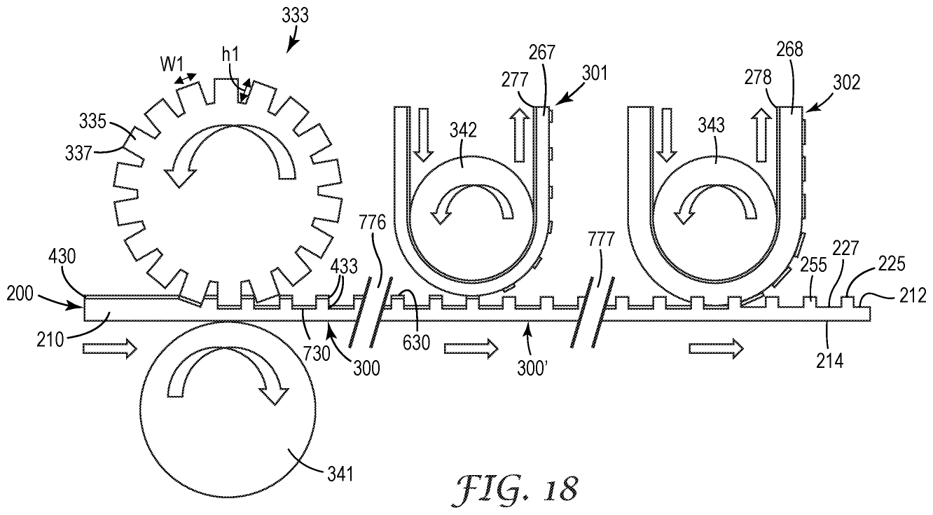

In some embodiments, the patterned article 100′ is configured such that the second functional layer 230 is transferrable from the carrier layer 110 to a first adhesive layer 267 (see, e.g., FIG. 18) leaving the first functional layer 130 disposed on the carrier layer 110. For example, after the second functional layer 230 has been transferred, the patterned article 100′ may then correspond to patterned article 100. In some embodiments, the patterned article 100 is configured such that the first functional layer 230 is transferrable from the carrier layer 110 to an adhesive layer 268 (see, e.g., FIG. 18). In some embodiments, the patterned article 100′ is a transfer article configured such that the second functional layer 230 is transferrable from the carrier layer 110 to a first adhesive layer 267 leaving the first functional layer 130 disposed on the carrier layer 110 such that the first functional layer 130 is transferrable from the carrier layer 110 to a second adhesive layer 268. As described further elsewhere herein, the carrier layer 110 can include a release coating to facilitate the transfer of the first and second functional layer 130 and 230.

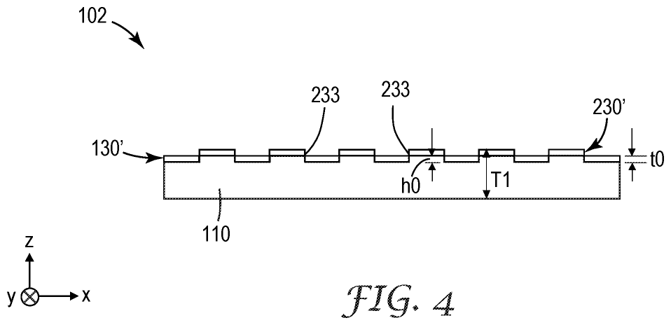

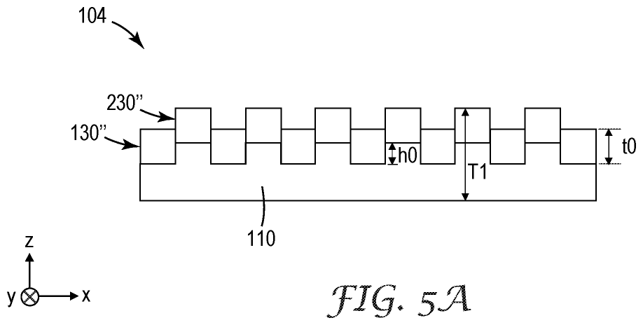

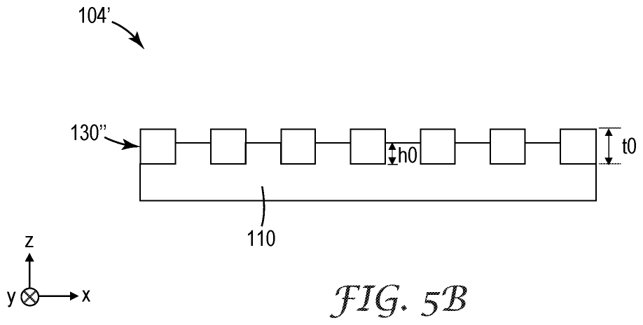

In some embodiments, the first major surface 112 of the carrier layer 110 includes a plurality of structures 129 having an average width W0 along at least one direction and defining gaps therebetween having an average width W1 along at least one direction. The plurality of structures 129 have an average height h0 and the first functional layer has an average thickness to. The second functional layer 230 can have an average thickness about the same (e.g., within 10%, or within 5%, or within 3%) as the average thickness to of the first functional layer 130. The average height h0 can be greater than the average thickness t0 as schematically illustrated in FIGS. 2-3, or can be about the same as the average thickness to as schematically illustrated in FIG. 4, or can be less than the average thickness to as schematically illustrated in FIGS. 5A-5B. In some embodiments, an average separation (h0) of the upper (125) and lower (127) portions along the thickness direction (z-direction) of the carrier layer 110 is greater than an average thickness t0 of the first functional layer 130. In some embodiments, an average separation (h0) of the upper (125) and lower (127) portions along the thickness direction (z-direction) of the carrier layer 110 is less than an average thickness t0 of the first functional layer 130″. In some embodiments, an average separation (h0) of the upper (125) and lower (127) portions along the thickness direction (z-direction) of the carrier layer 110 is within 10% of an average thickness t0 of the first functional layer 130′. FIGS. 4 and 5A are schematic cross-sectional views of patterned articles 102 and 104, respectively, which may correspond to patterned article 100′ except for the thickness of the functional layers. FIG. 5B is a schematic cross-sectional view of patterned article 104′ which may correspond to patterned article 104 except that the functional layer 230″ has been removed. In patterned article 102, the functional layers 130′ and 230′ each have an average thickness about the same as the average separation (h0) of the upper (125) and lower (127) portions along the thickness direction (z-direction) of the carrier layer 110. In patterned article 104, the functional layers 130″ and 230″ each have an average thickness greater than the average separation (h0) of the upper (125) and lower (127) portions along the thickness direction (z-direction) of the carrier layer 110.

In some embodiments, when the patterned article 100 is disposed on a planar surface 174, the upper (125) and lower (127) portions of the first major surface 112 are disposed in respective first and planes 176 and 178 separated from one another (e.g., by an average separation h0) along the thickness direction (z-direction) of the carrier layer 110.

In some embodiments, an average separation (h0) of the upper (125) and lower (127) portions along the thickness direction (z-direction) of the carrier layer 110 is at least 0.3 micrometers, or at least 0.5 micrometers, or at least 0.7 micrometers. In some such embodiments, or in other embodiments, the average separation (h0) of the upper (125) and lower (127) portions along the thickness direction (z-direction) of the carrier layer is no more than 10 micrometers, or no more than 5 micrometers, or no more than 3 micrometers, or no more than 2 micrometers, or no more than 1.5 micrometers. For example, the average separation can be in a range of 0.3 micrometers to 10 micrometers, or 0.5 micrometers to 5 micrometers, or 0.5 micrometers to 3 micrometers, or 0.7 micrometers to 2 micrometers. In some embodiments, the first and/or second functional layer has a thickness in a range of 100 nm to 2000 nm. In some embodiments, the patterned article (e.g., 100, 100′, 102, 104, or 104) has a thickness T1 of less than 10 micrometers, or less than 5 micrometers, or less than 3 micrometers, for example. The thickness T1 of the patterned article can be greater than 0.5 micrometers, for example.

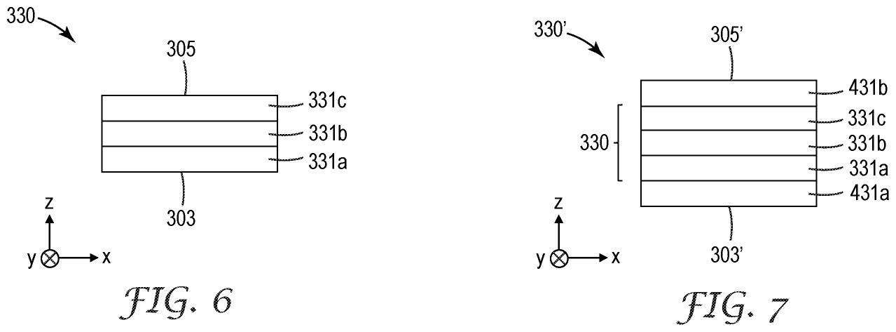

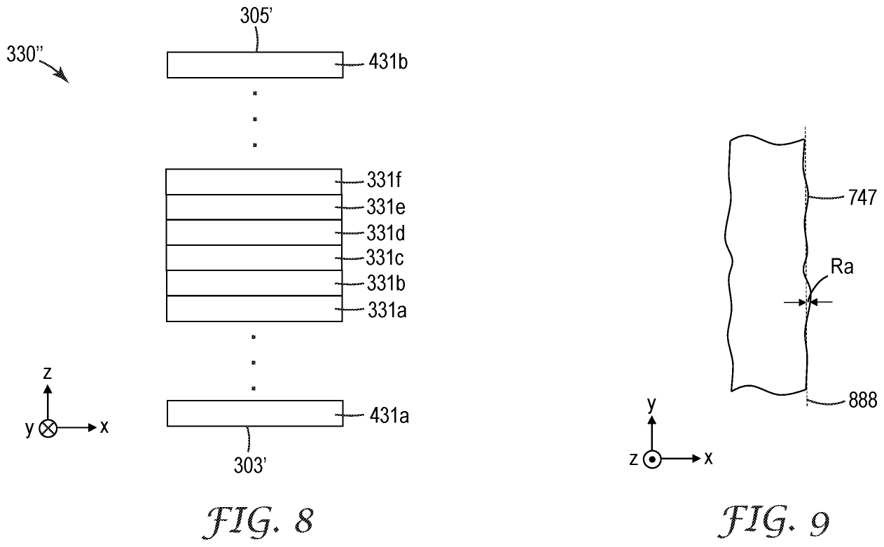

FIG. 6-8 are schematic cross-sectional views of functional layer 330, 330′, and 330″, any of which may correspond to functional layer 130 or 230 (e.g., in some embodiments, functional layers 130 and 230 may be obtained by micro-cutting functional layer 330, 330′, or 330″ as described further elsewhere herein). Functional layer 330 includes layers 331a, 331b, and 331c and has opposing first and second outermost major surfaces 303 and 305. In some embodiments, the 331a, 331b, and 331c layers include at least one metal layer and at least one metal oxide or metal nitride layer. Functional layer 330′ has opposing first and second outermost major surfaces 303′ and 305′ includes functional layer 330 disposed between first and second layers 431a and 431b. The first and second layers 431a and 431b may be first and second organic layers and/or first and second polymeric layers. Polymeric layers can be understood to be organic polymeric layers, unless indicated differently. Functional layer 330″ includes the first and second layers 431a and 431b and at least layers 331a through 331f disposed between the first and second layers 431a and 431b. In some embodiments, a functional layer includes a plurality of inorganic layers (e.g., at least one metal layer and at least one metal oxide layer). In some embodiments, each inorganic layer of a functional layer has a thickness of about 1 nm to about 500 nm, or about 1 nm to about 250 nm, or about 3 nm to about 200 nm, or about 5 nm to about 100 nm, or about 10 nm to about 50 nm, for example.

In some embodiments, the functional layer (or the first functional layer 130 and/or the second functional layer 230, for example) can include at least one organic layer and at least one inorganic layer. For example, the patterned article can include a first functional layer that includes at least one first micro-cut inorganic layer and that further includes at least one micro-cut organic layer that may be substantially coextensive with the first micro-cut inorganic layer. The patterned article can further include a second functional layer that includes at least one second micro-cut inorganic layer and that may further include at least one micro-cut organic layer that may be substantially coextensive with the second micro-cut inorganic layer. The patterning techniques described herein can be applied to functional layers including at least one organic layer and at least one inorganic layer in a single step (e.g., using tool 333), in contrast to conventional patterning techniques where the organic layer(s) and inorganic layer(s) would be patterned in separate (e.g., etching) steps. For example, the functional layer can include a metal layer disposed between polymeric layers. Including polymer layers with the metal layer in a functional layer has been found to improve the mechanical robustness of the functional layer during processing, for example.

In some embodiments, a functional layer includes at least two metal layers. In some embodiments, a functional layer includes at least two metal oxide layers, or at least two metal nitride layers, or at least one metal oxide layer and at least one metal nitride layer. For example, for any of functional layers 330, 330′ or 330″, layer 331a can be a metal layer, layer 331b can be a metal oxide layer or a metal nitride layer, and layer 331c can be a metal layer: or layer 331a can be a metal oxide layer or a metal nitride layer, layer 331b can be a metal, and layer 331c can be a metal oxide layer or a metal nitride layer. In some embodiments of functional layer 330″, layer 331a is a metal layer, layer 331b is a metal oxide layer, layer 331c is a polymeric layer, layer 331d is a metal oxide layer, layer 331e is a metal layer, and layer 331f is a metal oxide layer. In some embodiments, one or more of these metal oxide layers is replaced with a metal nitride layer. Other suitable functional layers are described in International Appl. Pub. No. WO 2020/240419 (Gotrik et al.), for example.

In some embodiments, at least one of the first and second polymeric layers 431a and 431b includes or is formed from an acrylate or an acrylamide. In some embodiments, the first and second polymeric layers 431a and 431b are or include respective first and second acrylate layers.

Suitable metals for a metal layer include copper, aluminum, silver, gold, titanium, indium, tin, zinc, zirconium, and alloys thereof, for example. Suitable oxides for a metal oxide layer include aluminum oxide, silicon oxide, silicon aluminum oxide, aluminum-silicon-oxy-nitride, CuO, silver oxide, TiO₂, ITO, ZnO, aluminum zinc oxide, ZrO₂, and yttria-stabilized zirconia, for example. Suitable nitrides include aluminum-silicon-nitride, Si₃N₄ and TiN, for example. Oxides or nitrides of any of the metals described herein for a metal layer may be used in an oxide or nitride layer. Since silicon is a metalloid, a silicon oxide will be considered to be a metal oxide and a silicon nitride will be considered to be a metal nitride, as the terms are used herein.

In some embodiments, the functional layer (e.g., functional layer 130, 230, 330, 330′, or 330″ or another functional layer described elsewhere herein) includes at least one micro-cut metal layer. In some embodiments, the at least one micro-cut metal layer includes or is formed from silver. For example, layer 331b can be a silver layer and each of layers 331a and 331b can be a metal oxide layer. Oxide protected silver layers are useful in plasmonic applications, for example. In some embodiments, a micro-cut functional layer includes an oxide protected silver layer between polymeric layers (e.g., layers 431a and 431b). The methods of the present description can, according to some embodiments, allow a functional layer that includes an oxide protected silver layer and that includes polymeric layers to be patterned by micro-cutting. It has been found that it is difficult to make patterned functional layers including an oxide protected silver layer and polymeric layers using conventional techniques (e.g., dry or wet lithography).

The line edge roughness of a cut edge can be substantially smaller than those resulting from conventional patterning processes such as lift off lithography, for example. FIG. 9 is a schematic top plan view of a patterned functional layer illustrating a line edge roughness, according to some embodiments. The roughness parameter Ra may be used for the line edge roughness. For example, the edge 747 has a line edge roughness Ra which can be described as the mean of an absolute value of displacement of the edge 747 from the mean location 888 of the edge 747. In some embodiments, an average line edge roughness Ra of a plurality of cut edges and/or of a pattern of cuts can be less than 1 micrometer, or less than 500 nm, or less than 100 nm and may be as low as 10 nm, for example. In some embodiments, a patterned article includes at least one first micro-cut inorganic layer (e.g., disposed on a lower portion of a microstructured major surface) including a plurality of cut edges having an average line edge roughness Ra of less than 1 micrometer or in a range described elsewhere herein. In some embodiments, the patterned article also includes at least one second micro-cut inorganic layer (e.g., disposed on an upper portion of a microstructured major surface) including a plurality of cut edges having an average line edge roughness Ra of less than 1 micrometer or in a range described elsewhere herein. In some embodiments, a patterned article includes at least one micro-cut metal layer where each micro-cut metal layer has a pattern of cuts. In some embodiments, for each micro-cut metal layer, an average line edge roughness Ra of the pattern of cuts is less than about 1 micrometer or in a range described elsewhere herein.

The various layers of functional layer 330, 330′, and 330″ may be applied by reactive evaporation, (e.g., reactive) sputtering, chemical vapor deposition, plasma enhanced chemical vapor deposition, and/or atomic layer deposition, for example. Suitable methods of forming the functional layer are described in U.S. Pat. Appl. Pub. No. 2012/0208033 (Weigel et al.) and in in U.S. Pat. No. 4,696,719 (Bischoff): U.S. Pat. No. 4,722,515 (Ham): U.S. Pat. No. 4,842,893 (Yializis et al.): U.S. Pat. No. 4,954,371 (Yializis), U.S. Pat. No. 5,018,048 (Shaw et al.): U.S. Pat. No. 5,032,461 (Shaw et al.): U.S. Pat. No. 5,097,800 (Shaw et al.): U.S. Pat. No. 5,125,138 (Shaw et al.): U.S. Pat. No. 5,440,446 (Shaw et al.): U.S. Pat. No. 5,547,908 (Furuzawa et al.): U.S. Pat. No. 6,045,864 (Lyons et al.); U.S. Pat. No. 6,231,939 (Shaw et al.): U.S. Pat. No. 6,214,422 (Yializis): U.S. Pat. No. 8,658,248 (Anderson et al.): U.S. Pat. No. 9,034,459 (Condo et al.): and U.S. Pat. No. 10,693,024 (Weigel et al.), for example.

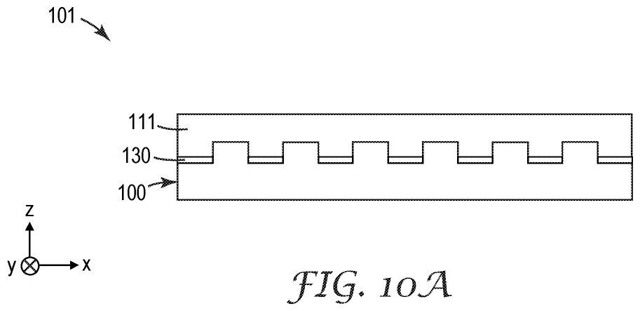

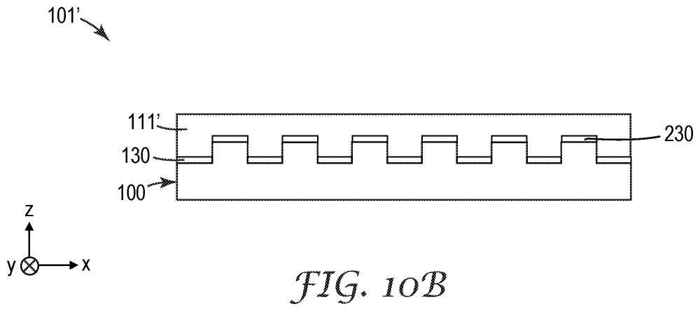

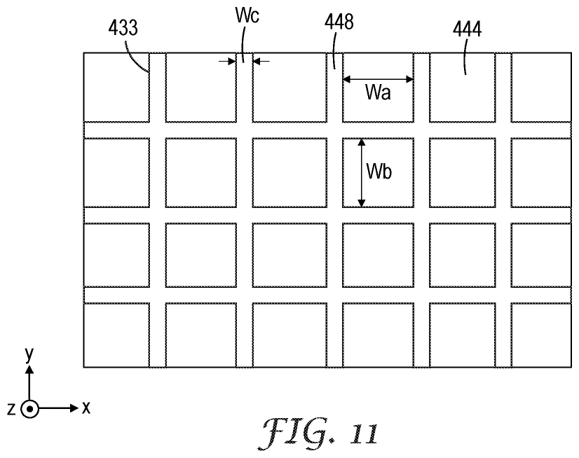

Any of the patterned articles 100, 100′, 102, 104, 104 may further include an overcoat disposed over the first major surface 112. FIGS. 10A-10B schematically illustrate patterned articles 101 and 101′ including respective overcoats 111 and 111′ disposed over respective patterned articles 100 and 100′. The overcoats 111, 111′ may be provided to alter dielectric properties and/or to protect the functional layer(s). In some embodiments, the overcoats 111, 111′ may be adapted to be transferred with the functional layer(s) 130 and/or 230, for example (e.g., in some embodiments, the overcoats are conformal coatings that can be transferred with the functional layer(s)). In other embodiments, the overcoats 111, 111′ may be provided when the corresponding patterned article 100, 100′, for example, is not intended to be used as a transfer article.

FIGS. 11-13 are schematic top plan views of patterned articles including a plurality of spaced apart plates 444 and a continuous pattern 448 (e.g., a mesh pattern) separated from one another along the pattern of cuts 433. The plates 444 may correspond to one of the first and second functional layers 130 and 230 (or to one of the first and second inorganic layers 131 and 231) and the pattern 448 may correspond to the other of the first and second functional layers 130 and 230 (or to the other of the first and second inorganic layers 131 and 231). In some embodiments, the at least one second micro-cut inorganic layer 231 includes a plurality of spaced apart plates 444. In some such embodiments, or in other embodiments, the at least one first micro-cut inorganic layer 131 includes a mesh pattern. In some embodiments, the at least one second micro-cut inorganic layer 231 includes a mesh pattern 448. In some such embodiments, or in other embodiments, the at least one first micro-cut inorganic layer 131 includes a plurality of spaced apart plates 444. In various embodiments, the exposed surfaces of the plates 444 may be substantially flat or may be contoured.

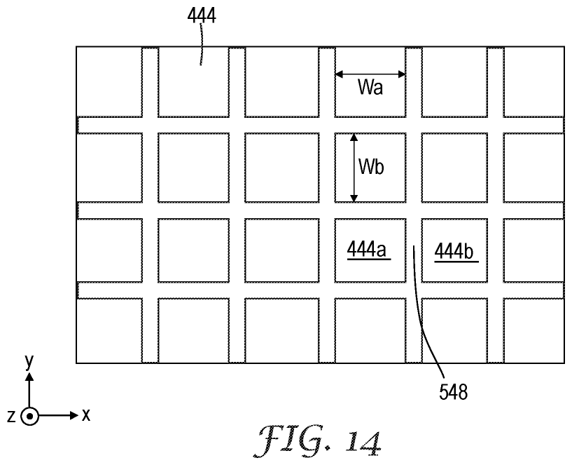

FIG. 14 is a schematic top plan view of a plurality of spaced apart plates 444 that may correspond to a patterned article (e.g., patterned article 100) after a second functional layer 230 disposed in a mesh pattern has been removed or that may correspond to a second functional layer 230 disposed in a pattern of plates after it has been transferred (e.g., to an adhesive layer) from a patterned article (e.g., patterned article 100′), for example.

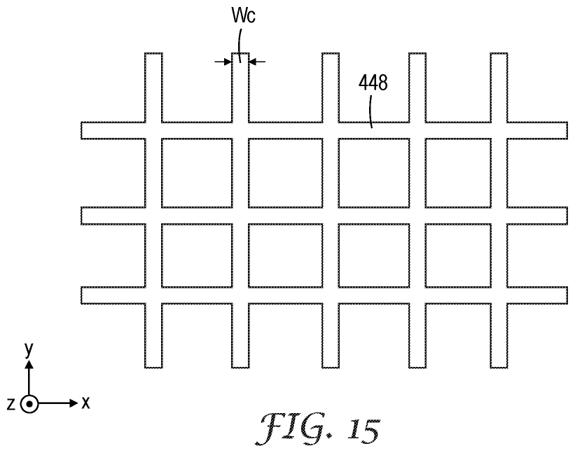

FIG. 15 is a schematic top plan view of a mesh pattern 448 that may correspond to a patterned article (e.g., patterned article 100) after a second functional layer 230 disposed in a pattern of spaced apart plates has been removed or that may correspond to a second functional layer 230 disposed in a mesh after it has been transferred (e.g., to an adhesive layer) from a patterned article (e.g., patterned article 100′), for example.

The plates 444 have orthogonal in-plane dimensions of Wa and Wb and the mesh pattern 448 has a line width Wc. In some embodiments, at least one of Wa and Wb is less than 2000 micrometers, or less than 1000 micrometers, or less than 500 micrometers, or less than 250 micrometers, or less than 150 micrometers, or less than 100 micrometers. In some such embodiments, or in other embodiments, each of Wa and Wb is at least 10 micrometers or at least 20 micrometers. In some embodiments, 0.2<Wa/Wb<5 or 0.25<Wa/Wb<4, or ⅓<Wa/Wb<3. In some embodiments, the line width Wc is at least 0.25 micrometers, or at least 0.5 micrometers, or at least 1 micrometer, or at least 2 micrometers, or at least 3 micrometers. In some such embodiments, or in other embodiments, the line width Wc is no more than 100 micrometers, or no more than 50 micrometers, or no more than 30 micrometers, or no more than 20 micrometers, or no more than 10 micrometers. For example, in some embodiments, the line width Wc is in a range of 0.5 micrometers to 50 micrometers, or 1 micrometers to 50 micrometers, or 2 micrometers to 30 micrometers, or 2 micrometers to 20 micrometers. In some embodiments, a center-to-center spacing between plates 444 (along the x-direction and/or along the y-direction) is less than 2000 micrometers, or less than 1000 micrometers, or less than 500 micrometers, or less than 250 micrometers, or less than 150 micrometers, or less than 100 micrometers. In embodiments, where the plates 444 are rectangular, Wa and Wb are the width and length of the rectangular shape, which may be a square shape since a square is a special case of a rectangle. The plates 444 can have any other suitable shape such as circular or elliptical. For a general shape, Wa can be taken to be the length of the shortest in-plane line extending entirely across the shape and passing through a centroid of the shape while Wb can be understood to be the largest dimension of the shape in an in-plane direction orthogonal to the shortest in-plane line.

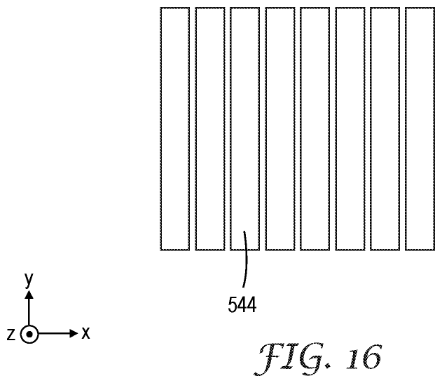

FIG. 16 is a schematic top plan view of a plurality of spaced apart strips 544 extending along a same first direction (y-direction). The strips 544 may correspond to the first or second functional layer 130 or 230 or may correspond to the at least one first micro-cut inorganic layer or the at least one second micro-cut inorganic layer. In some embodiments, the at least one first micro-cut inorganic layer 131 includes a plurality of spaced apart strips 544 extending along a same first direction (y-direction). In some embodiments, the at least one second micro-cut inorganic layer 231 includes a plurality of spaced apart strips 544 extending along a same first direction (y-direction). The strips 544 can be considered to be plates with a large aspect ratio (e.g., Wb/Wa>5 or Wb/Wa>10).

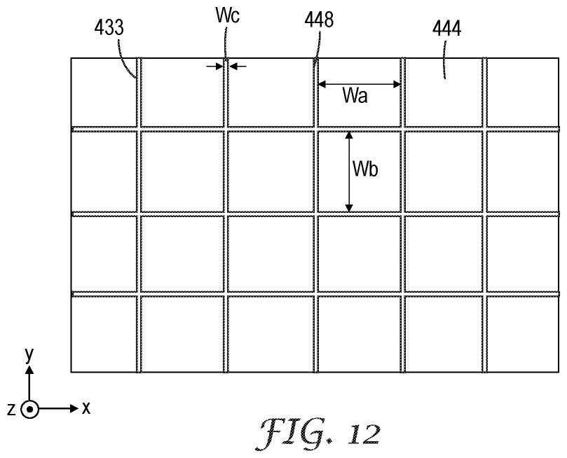

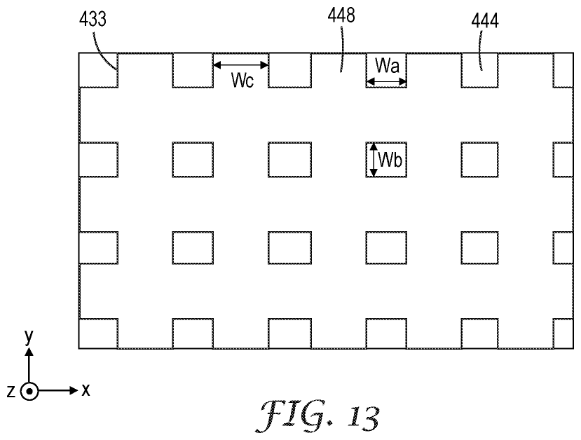

In some embodiments, in a top plan view (along the minus z-direction), the lower portion 127 has a total area of no more than 50 percent of a total area of the first major surface 112. For example, the mesh pattern 448 of FIG. 12 may be disposed on the lower portion 127. As another example, the plates 444 of FIG. 13 may be disposed on the lower portion 127. The total area of the first major surface 112 in top plan view includes the areas of the upper and lower portions 125 and 127 but does not include the areas of vertical sidewalls. In some embodiments, in a top plan view, the lower portion has a total area less than 50 percent, or less than 40 percent, or less than 30 percent, or less than 20 percent, or less than 10 percent of a total area of the first major surface. In some such embodiments, or in other embodiments, in a top plan view, the lower portion 127 has a total area of at least 0.01 percent, or at least 0.1 percent, or at least 0.5 percent, or at least 1 percent, or at least 2 percent of the total area of the first major surface. In some embodiments, the second functional layer 230 is transferred from the carrier layer 110 leaving the first functional layer 130 disposed on the lower portion 127 which may then be transferred to another layer. In some embodiments, it may be desired that an article including the first functional layer (e.g., disposed on the lower portion 127 or transferred to another layer) be optically transmissive. In some such embodiments, or in other embodiments, it may be preferred that in a top plan view, the lower portion 127 has a total area of less than 10% of a total area of the first major surface 112. For example, in a top plan view, the lower portion 127 may have a total area of about 8% or less of a total area of the first major surface 112.

In some embodiments, the first and/or second functional layer 130, 230 is free of cracks or substantially free of cracks. In some embodiments, the first and/or second micro-cut inorganic layer 131, 231 is free of cracks or substantially free of cracks. A layer may be described as substantially free of cracks when cracks are not human visible (by a person with unaided eyes having 20/20 vision under ordinary room lighting conditions which may be as described in the UNE-EN 12464-1:2012 standard) at a 10 cm spacing. Cracks are distinct from cuts since cutting leaves signatures (e.g., toolmarks) distinct from those of cracks. In some embodiments, the first and/or second inorganic layer 131, 231 includes a plurality of cut (e.g., micro-cut) edges and no cracks extending between different cut edges.

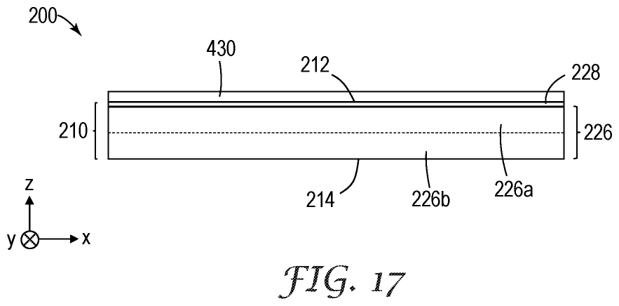

In some embodiments, the patterned article is a transfer article configured such that the first functional layer 130 and/or the second functional layer 230 is transferrable from the carrier layer 110 to an adhesive layer (see, e.g., 267 or 268 in FIG. 18). FIG. 17 is a schematic cross-sectional view of a transfer article 200 which may be used in making a patterned article as described further elsewhere herein and which includes a carrier layer 210 which may correspond to carrier layer 110 before it is patterned. The transfer article 200 includes a functional layer 430 (e.g., corresponding to functional layer 130 or 230 or another functional layer described elsewhere herein) and a carrier layer 210 that includes a substrate 226 and a release coating 228 disposed one the on the substrate 226 and facing the functional layer 430 (or the first functional layer 130 and/or the second functional layer 230, for example). The substrate 226 may be a monolithic substrate or may include two or more layers 226a and 226b as schematically indicated in FIG. 17. In some embodiments, the substrate 226 includes or is formed of polyethylene terephthalate (PET) or biaxially oriented polypropylene (BOPP). The PET may be uniaxially or biaxially oriented, for example. In some embodiments, the release coating 228 is or includes a metal layer or a doped semiconductor layer. The metal layer may conveniently be formed of Al, Zr, Cu, NiCr, NiFe, Ti, or Nb, and may have a thickness from about 3 nm to about 3000 nm, for example. The doped semiconductor layer may be formed of Si, B-doped Si, Al-doped Si, P-doped Si with thicknesses which may be from about 3 nm to about 3000 nm, for example. A particularly suitable doped semiconductor layer for the release layer is Al-doped Si, where the Al compositional percentage is about 10%. In some such embodiments, or in other embodiments, a release value between the release coating 228 and the functional layer 430 is from 2 to 50 grams/inch. In some embodiments, the carrier layer 110 or 210 is or includes aluminum coated PET or aluminum coated BOPP. The release layer may be prepared by evaporation, reactive evaporation, sputtering, reactive sputtering, chemical vapor deposition, plasma enhanced chemical vapor deposition, or atomic layer deposition, for example. Other suitable release coated substrates are described in International Appl. Pub. No. WO 2020/240419 (Gotrik et al.), for example.

The substrate 226 of the carrier layer 210 may be or include a low modulus layer (e.g., a layer having a Young's modulus in a range of 50 MPa to 1000 MPa, or 100 MPa to 500 MPa). For example, the substrate may include a first polymeric layer 226a (e.g., a PET or BOPP layer) facing the functional layer 430 and disposed on a second polymeric layer 226b which can be a low modulus layer. The low modulus layer can be an acrylic adhesive such as an acrylic pressure sensitive adhesive. The low modulus layer can reduce the pressure needed to complete the patterning process and may improve the faithfulness of the reproduction of a pattern of cutting edges from a micro-cutting tool, for example. In other embodiments, the substrate 226 is a monolithic PET or BOPP film, for example.

FIG. 18 is a schematic cross-sectional view of a method of making a patterned article 300 (e.g., corresponding to patterned article 100 or another patterned article described elsewhere herein) or 300′ (e.g., corresponding to patterned article 100′ or another patterned article described elsewhere herein) and of transferring functional layers of the resulting patterned article 300, 300′ to other layers to form patterned articles 301 and 302. Break symbols 776 and 777 are included to indicate that processes on the left and right of the break symbol 776, 777 may be carried out on a same or a different (e.g., continuous roll-to-roll) process line. In some embodiments, the portion to the right of break symbol 776 is omitted (or performed as a separate process) and the method is a method of making patterned article 300. In some embodiments, the portion to the right of break symbol 777 is omitted (or performed as a separate process) and the method is a method of making patterned article 300′ and/or patterned article 301. In some embodiments, the method is a method of making patterned article 301 and/or 302.

In some embodiments, a method for making a patterned article 300, 300′, 301, and/or 302 (or 100, 100′, or another patterned article described elsewhere herein) is provided. The method can include providing a transfer article 200, where the transfer article includes a carrier layer 210 having opposing first and second major surfaces 212 and 214, and a functional layer 430 disposed on the first major surface 212. The method can further include providing a tool 333 including a plurality of microstructures 335 where each microstructure includes at least one cutting edge 337; disposing the transfer article 200 and the tool 333 adjacent one another such that the functional layer 430 faces the plurality of microstructures 335: and contacting the transfer article 200 with the tool 333 such that the tool 333 embosses and cuts into the transfer article 200 to form a pattern of cuts 433 in the functional layer 430 and to form a plurality of structures 255 in the carrier layer defining upper and lower portions 225 and 227 of the first major surface 212. The lower portion 227 is disposed between the upper portion 225 and the second major surface 214. A first portion 630 of the functional layer 430 is disposed on the upper portion 225 of the first major surface 212, and a second portion 730 of the functional layer 430 disposed on the lower portion 227 of the first major surface 212. The first and second portions 630 and 730 of the functional layer 430 are separated from one another along the pattern of cuts 433. The first and second portions 630 and 730 of the functional layer 430 may correspond to the second and first functional layers 230 and 130, respectively, for example. The at least one cutting edge 337 can be a single continuous cutting edge when the second portion 730 includes a circular or elliptical plate, or the at least one cutting edge 337 can include at least two opposing cutting edges (e.g., opposing first and second cutting edges, and opposing third and fourth cutting edges) when the second portion is a rectangular plate, for example.

The step of contacting the transfer article 200 with the tool 333 such that the tool 333 embosses and cuts into the transfer article 200 to form a pattern of cuts 433 in the functional layer 430 and to form a plurality of structures 255 in the carrier layer defining upper and lower portions 225 and 227 of the first major surface 212 can be carried out at elevated temperatures (e.g., 80 to 120° C.) and/or with increased tool force (e.g., 500 to 20000 pounds per foot of a tool width) as this has been found to provide improved cutting and separation between the upper and lower portions.

In some embodiments, the patterned article 300 is a transfer article configured such that the first portion 630 of the functional layer 430 is transferrable from the carrier layer 210 to a first adhesive layer 267 leaving the second portion 730 of the functional layer 430 disposed on the carrier layer 210 such that the second portion 730 of the functional layer 430 is transferrable from the carrier layer 210 to a second adhesive layer 268.

The various arrows in FIG. 18 indicate the direction of motion of the tool 333 and the various rollers and films or other articles as the method is carried out. A roller 341 may be provided on an opposite side of the transfer article 200 from the tool 333 which may be a generally cylindrical tool. In some embodiments, the method includes transferring the first portion 630 to a first adhesive layer 267 to form a patterned article 301 that includes a layer 277 disposed on the first adhesive layer 267 opposite the transferred first portion 630. The layer 277 may be a release layer, for example. A roller 342 may be utilized in this step. In some embodiments, the method includes transferring the second portion 730 to a second adhesive layer 268 to form a patterned article 302 that includes a layer 278 disposed on the second adhesive layer 268 opposite the transferred second portion 730. The layer 278 may be a release layer, for example. A roller 343 may be utilized in this step.

In some embodiments, the functional layer 430 is an inorganic layer. In other embodiments, the functional layer 430 is an organic layer. In some embodiments, the functional layer 430 includes at least one inorganic layer (e.g., at least one of layers 331a to 331f) and/or the functional layer includes at least one organic layer (e.g., at least one of layers 431a and 431b).

As described further elsewhere herein, in some embodiments, one of the upper or lower portions 225 and 227 includes a mesh pattern 448 having an average line width Wc in a range of 0.5 micrometers to 50 micrometers or We can be in another range described elsewhere herein. In some embodiments, in a top plan view, the lower portion 227 has a total area less than 50 percent of a total area of the first major surface 212 or the total area of the lower portion 227 can be in any range described elsewhere herein. In some embodiments, the functional layer 430 has a thickness in a range of 100 nm to 2000 nm, and the patterned article 300, 300′, 301, or 302 may have a thickness of less than 10 micrometers, or less than 5 micrometers, or less than 3 micrometers, for example. In some embodiments, the plurality of microstructures 335 has an average width W1 in a range of 0.5 to 10 micrometers, for example. In some embodiments, the plurality of microstructures 335 has an average height h1 in a range of 0.5 to 50 micrometers or 0.5 to 20 micrometers, or 0.5 to 10 micrometers, for example.

FIG. 19 is a schematic cross-sectional view of a microstructure 535 of a tool. The microstructure may correspond to the microstructures 335 of the tool 333, for example. The microstructure 535 has opposing cutting edges 437 as is adapted to cut an element having a width W1 in a layer. The cutting edges 437 have a tip width Wt which may be twice a radius of curvature of the tip. In some embodiments, the tip width Wt can be less than about 1 micrometer, or less than about 0.5 micrometers, or less than about 0.3 micrometers, for example. In some such embodiments, or in other embodiments, the tip width Wt can be greater than about 0.01 micrometers or greater than about 0.05 micrometers, for example.

The patterned articles 301 and/or 302 can be used to make additional patterned articles by removing the layer 277 or 278 and adhering the exposed surface of the adhesive layer 267 or 268 to another surface. Alternatively, or in addition, further patterned articles can be made by adhering additional layers to the patterned articles 301 and/or 302.

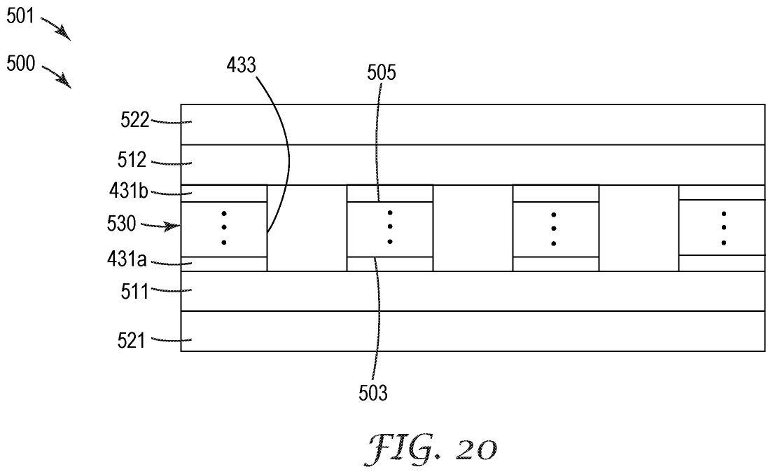

FIG. 20 is a schematic cross-sectional view of a patterned article 501, according to some embodiments. The patterned article 501 includes a multilayer film 500 which includes a first polymeric layer 431a: a functional layer 530 including opposing first and second major surfaces 503 and 505 (e.g., corresponding to 303 and 305), where the first major surface 503 is disposed on the first polymeric layer 431a, and where the functional layer 530 includes a multilayer stack (e.g. corresponding to 330 or the portion of 330″ between the 431a and 431b layers) including at least one micro-cut metal layer (e.g., one of 331a, 331b, or 331c) and at least one metal oxide or metal nitride layer (e.g., a different one of 331a, 331b, 331c); and a second polymeric layer 431b disposed on the second major surface of the functional layer. Each micro-cut metal layer can have an average thickness in a range of 5 nanometers to 500 nanometers, or 10 nanometers to 250 nanometers, and includes a pattern of cuts 433 forming either: (i) a pattern of discrete spaced apart plates 444 (or 544) corresponding to the pattern of cuts 433 and bounded by the cuts with substantially no portion of the metal layer disposed between closest adjacent plates 444a and 444b (e.g., any metal initially in the space 548 between the plates 444a and 444b after cutting the functional layer can be removed with the possible exception of small amounts of metal, such as metal flakes or trace amounts of metal, left behind when metal initially in the space 548 is removed), or (ii) a continuous pattern 448 corresponding to removing a pattern of discrete spaced apart plates 444 corresponding to the pattern of cuts 433 from the metal layer. The at least one metal oxide or metal nitride layer can be at least one metal oxide or metal nitride micro-cut layer and may have substantially the same pattern of cuts as the at least one micro-cut metal layer.

In some embodiments, the multilayer film 500, further includes a first adhesive layer 511 disposed on the first polymeric layer 431a: a first polymeric film layer 521 disposed on the first adhesive layer 511; a second adhesive layer 512 disposed on the second polymeric layer 431b; and a second polymeric film layer disposed 522 on the second adhesive layer 512. For example, the first adhesive layer 511 may correspond to one of the adhesive layers 267 and 268 schematically illustrated in FIG. 18, and the first polymeric film layer 521 may correspond to one of the layers 277 and 278 schematically illustrated in FIG. 18 or the layer 277 or 278 may be a release liner that is removed and replaced with a film layer permanently bonded to the adhesive layer. The second adhesive layer 512 and second polymeric film layer 522 may then be attached to the second polymeric layer 431b. The second adhesive layer 512 and second polymeric film layer 522 may be added to protect the functional layer 530, for example. In some embodiments, the second adhesive layer 512 and/or the second polymeric film layer 522 is optically clear (e.g., luminous transmittance of at least 80% and haze of no more than 10% as determined according to ASTM D1003-13 “Standard Test Method for Haze and Luminous Transmittance of Transparent Plastics”, for example). In some such embodiments, or in other embodiments, the first adhesive layer 511 and/or the first polymeric film layer 521 is optically clear. In some embodiments, the first polymeric film layer 521 is a release liner that is removed prior to applying the multilayer film to a substrate, for example. The layers 522, 512, and/or 521 may optionally be omitted.

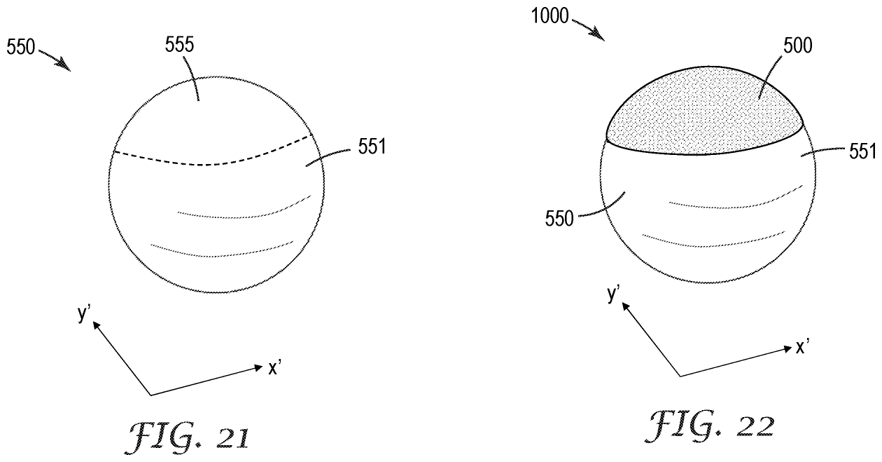

FIG. 21 is a schematic perspective view of a substrate 550 and FIG. 22 is a schematic perspective view of a patterned article 1000 including a multilayer film 500 dispose on a portion 555 of a major surface 551 of the substrate 550. In some embodiments, a patterned article 1000 includes a substrate 550, the multilayer film 500 disposed on, and substantially conforming to, at least a portion 555 of the of a major surface 551 of the substrate. The portion 555 of the major surface being 551 can be nonplanar and/or can be curved about two mutually orthogonal axes (e.g., x′- and y′-axes). A shape curved about two mutually orthogonal axes may alternatively, or in addition, be referred to as a shape having a compound curvature. In some embodiments, the multilayer film 500 is stretched and shaped such that the multilayer film 500 substantially conforms to at least a portion 555 of the of the major surface 551 of the substrate 550. For example, the multilayer film 500 can be initially a generally planar film as schematically illustrated in FIG. 20. To conform such a film to a nonplanar surface (e.g., of a sphere) curved about two mutually orthogonal axes such as the portion 555, the film is stretched and shaped such that it can conform to the portion 555 as schematically indicated in FIGS. 21-22.

In some embodiments, if the functional layer (e.g., 130, 230, 330, 330′, 330″, 430) includes metal or metal oxide layers, the patterned articles of the present description can have at least one of an anti-microbial, an antibacterial, or an anti-biofilm, effect. A wide variety of metal oxides MOx may be used in such an application, as long as the metal oxide layer exhibits at least a 1-log microbial reduction, at least a 2-log reduction, at least a 3-log reduction, or at least a 4-log reduction, against S. aureus and S. mutans following 24 hour contact. Log reductions are measured after testing according to ISO test method ISO 22196:2011, “Measurement of antibacterial activity on plastics and other non-porous surfaces,” with appropriate modifications of the test method to accommodate the test materials.

Suitable antimicrobial metals and metal oxides for the functional layer include, for example, silver, silver oxide, copper oxide, gold oxide, zinc oxide, magnesium oxide, titanium oxide, chromium oxide, and mixtures, alloys and combinations thereof. In some embodiments, the metal oxide in the functional layer is chosen from AgCuZnOx, Ag doped ZnOx, Ag doped ZnO, Ag doped TiO2, Al doped ZnO, and TiOx, for example.

In various embodiments, the functional layer can include any antimicrobially effective amount of a metal, a metal oxide MOx, or mixtures and combinations thereof. In various embodiments, the metal oxide layer can include, for example, less than 100 mg, less than 40 mg, less than 20 mg, or less than 5 mg MOx per 100 cm2.

In some embodiments, the functional layer can have dielectric properties, and can be transmissive to electromagnetic signals over a selected frequency range, which can be useful, for example, in 5G or other communication devices. For example, if the patterned functional layer has a tan 8 of about 0.12 or less when measured in a cavity of a split post dielectric resonator at 9.5 GHz as set forth in IPC Standard TM-650 2.5.5.13, the layer can be more transparent to communication signals transmitted between mobile devices as compared to their non-micro-cut state. In some embodiments, the micro-cut functional layer can have a real permittivity of about 33, and a complex permittivity of about 4.

In some embodiments, the shapes and sizes of the plates 444 and/or the mesh pattern 448 can be configured to provide transparency for near infrared signals, which can enable the formation of highly conformable near-IR sensor cover construction on a surface. In some embodiments, the plates and the spaces interspersed therebetween can be configured to provide reflectivity for near infrared signals and transparency for visible light. For example, such a configuration can form a highly conformable visible light sensor cover.

In some embodiments, the shapes and sizes of the plates 444 and/or the mesh pattern 448 can result in color changing, reflective, transmissive, or other aesthetic effects for the functional layer, which can provide a useful decorative film that may be applied to complex or compound surfaces such as, for example, vehicle exteriors or interiors. For example, in some embodiments, the transfer article including the micro-cut inorganic layer is reflective at visible wavelengths from 400-750 nm or 400-700 nm and at least partially transparent at wavelengths of greater than about 830 nm. For example, when exposed to ambient conditions, some plates 444 may oxidize over time, and this detectable color change can be used to evaluate, for example, a shelf life of a product. If the color change is not desirable, one or both surfaces of a micro-cut metal layer can be overlain by one or more protective barrier layers of, for example, a metal oxide. In some embodiments, the metal layers can be configured such that the plates provide a color-changing effect when exposed to light over a selected wavelength range such as, for example, when the article is stretched in two or three dimensions over a surface with compound curvature.

### EXAMPLES

The examples are for illustrative purposes and are not meant to be limiting on the scope of the appended claims. All parts, percentages, ratios, etc. in the example and the rest of the specification are by weight, unless noted otherwise.

Materials and Sources

| Abbreviation | Description |
|---|---|
| SV480 | 3M ENVISION Print Wrap Film SV480mc, a on PVC |
| | print wrap film (0.0508 mm), was obtained from |
| | the 3M Company, Saint Paul, MN. |
| 8518 | Transparent PVC film with an adhesive coating |
| | was obtained from the 3M Company as 3M 8518 |
| | SCOTCHCAL Gloss Overlaminate, a transparent |
| | PVC film with an adhesive coating, was obtained |
| | from the 3M Company, Saint Paul, MN |
| OCA | 3M Optically Clear Adhesive 8171, an acrylic- |
| | based adhesive (0.0250 mm thick), was obtained |
| | from the 3M Company, Saint Paul, MN |

Microcut & Emboss Tools were Prepared by the Following Specification:

The tools were generated by diamond cutting 12 micrometer (μm) deep trenches into a cylindrical roll using conventional machining methods. The trenches were cut in a 45 degree and a −45 degree directions relative to the circumferential direction of the roll. The pitch between the trenches was 300 μm. The resultant tool was intersecting trenches that formed diamond shape raised areas, with 45 degree intersecting trenches. Half of the patterns were cut with tools that had 0.15 μm tips on the edge of the diamond. The diamond edges with the tip had 60 degree included angles.

Next the pattern was removed from the roll by peeling a thin layer of copper off the cylinder surface with the trench pattern describe above. This thin copper sheet was then Ni plated using traditional Ni electroplating methods to form the negative of the cut trench pattern. The Nickel sheets electroplated from the pattern with the edge features, resulted in raised edges in the nickel sheet.

The Nickel shims were then back side ground smooth and welded together to form a roll sleeve. The sleeve was then mounted onto a temperature-controlled mandrel, and the mandrel was installed in a laminator.

Pattern Description

| Abbreviation of | Height | Rib side angles in | Tip width |
|---|---|---|---|
| Pattern | (um) | degrees (included) | (um) |
| Microcut & | 12 | 8 | 10 |
| EmbossTool1 | | | |
| Microcut & | 12 | 8 | 4 |
| EmbossTool2 | | | |

### Test Methods

### Micro-Cut Confirmation Test

A VHX-6000 series Keyence digital microscope with a 100× objective lens (Keyence Corporation of America, Itasca, IL) was used in visible light transmission mode to view light leakage from fractures in the film article. Fractures were visible as higher visible light transmission regions surrounded by the lower visible light transmission non-fractured surfaces.

### Preparative Example 1. Ag Coated Transfer Stack

The transfer film of this Example was made on a roll to roll vacuum coater similar to the coater described in U.S. Pat. Appl. Pub. No. 2010/0316852 A1 (Condo et al.) with the addition of a second evaporator and curing system located between the plasma pretreatment station and the first sputtering system, and using evaporators as described in U.S. Pat. No. 8,658,248 (Anderson et al.). The coater was threaded up with an indefinite length roll (980 microinch (0.0250 mm) thick, 14 inch (35.6 cm) wide) of an aluminized biaxially-oriented polypropylene film release layer (obtained under the trade designation TORAYFAN PMX2 from Toray Plastics (America), North Kingstown, RI). The release layer was then advanced at a constant line speed of 32 fpm (9.8 meters/minute).

A first acrylate layer, tricyclodecane dimethanol diacrylate (obtained under the trade designation SARTOMER SR833S from Sartomer USA, Exton, PA) was applied to the release layer by ultrasonic atomization and flash evaporation to make a coating width of 12.5 inches (31.8 cm). The flow of liquid monomer into the evaporator was 0.67 mL/minute. The nitrogen gas flow rate was 100 standard cubic centimeters per minute (sccm) and the evaporator temperature was set at 500° F. (260° C.). The process drum temperature was 14 ºF (−10° C.). This monomeric coating was subsequently cured immediately downstream with an electron beam curing gun operating at 7.0 kV and 10.0 mA to result in a 180 nm acrylate thickness.

On top of the first acrylate layer, a silver reflector layer was deposited by direct current (DC) sputtering of a >99% silver cathode target. The system was operated at 3 kW with a 30 fpm (9.1 meters per minute) line speed. Two subsequent depositions with the same power and line-speed were done to create a 90 nm layer of silver.

On top of the silver layer, an oxide layer of silicon aluminum oxide was deposited by alternating current (AC) reactive sputtering. The cathode had a Si(90%)/Al(10%) target and was obtained from Soleras Advanced Coatings US (Biddeford, ME). The voltage for the cathode during sputtering was controlled by a feed-back control loop that monitored the voltage and controlled the oxygen flow. The system was operated at 32 kW of power to deposit a 12 nm thick layer of silicon aluminum oxide onto the silver reflector. Similar to what is described in U.S. Pat. Appl. Pub. No. 2020/0016879 A1 (Gotrik et al.) and U.S. Pat. Appl. Pub. No. 2020/0136086 A1 (Gotrik et al.), the aluminum surface of the TorayFAN PMX2 film and the first organic layer would decouple with a 180 peel force of 7.2 g/in (0.283 g per mm).

### Preparative Example 2. Weather-Resistant Al-Based MIM Transfer Stack

The coater was threaded up with an indefinite length roll (980 microinch (0.0250 mm) thick, 14 inch (35.6 cm) wide) of an aluminized polyethylene (PET) film release layer (obtained under the trade designation TORAYFAN MT60 from Toray Plastics (America), North Kingstown, RI). The release layer with coated first acrylate layer was prepared according to the procedure described in the first part of Preparative Example 1. On the top of the first acrylate layer, an aluminum reflector layer was deposited. A conventional DC sputtering process employing argon gas and operated at 2 kW of power was employed to deposit a 60 nm thick layer of Al. The cathode Al target was obtained from ACI Alloys (San Jose, CA).

On top of the reflective Al layer, a second acrylate layer was applied. The second acrylate layer was produced from a monomer solution by atomization and evaporation of SARTOMER SR833S+3% CN 147 (obtained from Sartomer USA, Exton, PA). The acrylate layer was applied using a flow rate of the mixture into the atomizer of 0.67 mL/min: a gas flow rate of 60 sccm, and an evaporator temperature of 260° ° C. Once condensed onto the Al layer, the coated acrylate was cured with an electron beam operating at 7 kV and 10 mA to provide a 290 nm thick layer. This second acrylate layer provided the insulating layer of the functional metal-insulator-metal (MIM) transfer stack.

On top of the second acrylate layer, a first inorganic barrier layer was applied. The oxide material of the barrier layer was applied by an AC reactive sputter deposition process employing a 40 kHz AC power supply. The cathode had a Si(90%)/Al(10%) rotary target and was obtained from Soleras Advanced Coatings US. The voltage for the cathode during sputtering was controlled by a feed-back control loop that monitored the voltage and controlled the oxygen flow. The system was operated at 16 kW of power to deposit a 12 nm thick layer of silicon aluminum oxide onto second acrylate layer.

On top of the first inorganic barrier layer, a second reflective layer was deposited in a similar manner as the first reflective layer. A conventional DC sputtering process employing argon gas and operated at 2 kW of power was employed to deposit the second reflective layer as an 8 nm thick layer of Al.

On top of the second reflective layer, a second inorganic barrier layer was applied in the same manner as the first inorganic barrier layer.

A third acrylate layer was deposited on top of the second inorganic barrier layer. This layer was produced from monomer solution by atomization and evaporation of SARTOMER SR833S+6% DYNASYLAN 1189 (obtained from Evonik Industries, Essen, DE). The flow rate of this mixture into the atomizer was 0.67 mL/minute. The gas flow rate was 60 sccm, and the evaporator temperature was 260° C. Once condensed onto the second inorganic barrier layer, the coated acrylate was cured with an electron beam operating at 7 kV and 10 mA to provide a 290 nm thick layer. Similar to what is described in U.S. Pat. Appl. Pub. No. 2020/0016879 A1 (Gotrik et al.) and U.S. Pat. Appl. Pub. No. 2020/0136086 A1 (Gotrik et al.), the aluminum surface of the Toray MT60 film and the first organic layer would decouple with a 180 peel force of 7.2 g/in (0.283 g per mm).

### Example 1. Transfer-Based Micro Cut & Embossed Article

Preparative Example 1 was roll-to-roll laminated against Microcut & EmbossTool1 at 240 degrees F. and was backed by a steel roll laminator at 240 degrees F. using 500 pounds per linear inch nip lamination force and 3 pounds per inch input tension and 1 pound per inch output tension (after micro cut & embossing). Atomic force microscopy measured that the embossed region of the third acrylate layer was 600 nm below the surface of the surrounding non-embossed region of the third acrylate layer. Atomic force microscopy measured line edge roughness of the non-embossed region cut edge to be approximately 200 nm.

### Example 2. Transfer of Non-Embossed Regions

A first OCA film was quickly (<1 second) laminated to the non-embossed third acrylate layer of Example 1. The OCA was quickly (<1 second) removed bringing the contacted third acrylate and attached multilayers to the OCA surface. The remaining TORAYFAN MT60 release liner with remaining microcut and embossed features was set aside.

The “Micro-cut Confirmation Test” confirmed that micro-cuts with 10 um gaps were preset between the transferred multilayers on top of the OCA surface. Occasional inadvertent fractures were noted inside of the transferred multilayer regions.

### Example 3. Transfer of Embossed Regions

The adhesive surface of 8518 was subsequently laminated to the remaining TORAYFAN MT60 release liner with remaining microcut and embossed features from Example 2. The 8518 was slowly removed from the TORAYFAN MT60 bringing the microcut and embossed features with it. The “Micro-cut Confirmation Test” confirmed that 10 um multilayer features were present on the 8518 surface. Occasional fractures were noted along the 10 um wide multilayers present on the 8518 surface.

### Example 4

Example 1 was repeated with Microcut & EmbossTool2. Example 4 was observed under an atomic force microscope (AFM) and functional layers at different heights (see, e.g., FIG. 3) were observed.

### Example 5

Example 2 was completed with Example 4 instead of Example 1. 4 um gaps were present between the transferred multilayers on top of the OCA surface.

### Example 6

Example 3 was completed with Example 5 instead of Example 2. 4 um wide multilayer features were present on the 8518 surface. Atomic force microscopy measured line edge roughness of the non-embossed region cut edge to be approximately 600 nm.

### Example 7

Example 1 was repeated with Preparative Example 2. Example 7 was observed under an atomic force microscope (AFM) and functional layers at different heights (see, e.g., FIG. 3) were observed.

### Example 8

Example 2 was completed with Example 7 instead of Example 1. Far fewer inadvertent fractures were noted inside of the transferred multilayer regions when compared to Example 2.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A patterned article, comprising:
a carrier layer comprising a microstructured first major surface and an opposing second major surface, the first major surface comprising pluralities of upper and lower edges spaced apart along a thickness direction of the carrier layer and defining respective upper and lower portions of the first major surface, the lower portion disposed between the upper portion and the second major surface; and
a first functional layer disposed on the lower, but not the upper, portion of the first major surface, the first functional layer comprising at least one first micro-cut inorganic layer comprising a plurality of cut edges substantially coextensive with the plurality of lower edges.

2. The patterned article of claim 1 further comprising a second functional layer disposed on the upper, but not the lower, portion of the first major surface, the second functional layer comprising at least one second micro-cut inorganic layer comprising a plurality of cut edges substantially coextensive with the plurality of upper edges.

3. The patterned article of claim 2 being a transfer article configured such that the second functional layer is transferrable from the carrier layer to a first adhesive layer leaving the first functional layer disposed on the carrier layer such that the first functional layer is transferrable from the carrier layer to a second adhesive layer.

4. The patterned article of claim 2, wherein the at least one second micro-cut inorganic layer comprises a plurality of spaced apart plates.

5. The patterned article of claim 1, wherein the at least one first micro-cut inorganic layer comprises a mesh pattern.

6. The patterned article of claim 1, wherein when the patterned article is disposed on a planar surface, the upper and lower portions of the first major surface are disposed in respective first and planes separated from one another along the thickness direction of the carrier layer.

7. The patterned article of claim 1, wherein an average separation of the upper and lower portions along the thickness direction of the carrier layer is in a range of 0.3 micrometers to 10 micrometers.

8. A method for making a patterned article, the method comprising:
providing a transfer article, the transfer article comprising:
a carrier layer having opposing first and second major surfaces; and
a functional layer disposed on the first major surface;
providing a tool comprising a plurality of microstructures, each microstructure comprising at least one cutting edge;
disposing the transfer article and the tool adjacent one another such that the functional layer faces the plurality of microstructures; and
contacting the transfer article with the tool such that the tool embosses and cuts into the transfer article to form a pattern of cuts in the functional layer and to form a plurality of structures in the carrier layer defining upper and lower portions of the first major surface, the lower portion disposed between the upper portion and the second major surface, a first portion of the functional layer disposed on the upper portion of the first major surface, a second portion of the functional layer disposed on the lower portion of the first major surface, the first and second portions of the functional layer separated from one another along the pattern of cuts.

9. The method of claim 8, wherein the functional layer comprises at least one inorganic layer

10. The method of claim 8, wherein the functional layer comprises at least one organic layer.

11. The method of claim 8, where the patterned article is a transfer article configured such that the first portion of the functional layer is transferrable from the carrier layer to a first adhesive layer leaving the second portion of the functional layer disposed on the carrier layer such that the second portion of the functional layer is transferrable from the carrier layer to a second adhesive layer.

12. The method of claim 8, wherein one of the upper or lower portions comprises a mesh pattern comprising an average line width in a range of 0.5 micrometers to 50 micrometers.

13. The method of claim 8, wherein in a top plan view, the lower portion has a total area less than 40 percent of a total area of the first major surface.

14. A patterned article comprising a multilayer film, the multilayer film comprising:
a first polymeric layer;
a functional layer comprising opposing first and second major surfaces, the first major surface disposed on the first polymeric layer, the functional layer comprising a multilayer stack comprising at least one micro-cut metal layer and at least one metal oxide or metal nitride layer, each micro-cut metal layer having an average thickness in a range of 5 nanometers to 500 nanometers and comprising a pattern of cuts forming either:
(i) a pattern of discrete spaced apart plates corresponding to the pattern of cuts and bounded by the cuts with substantially no portion of the metal layer disposed between closest adjacent plates, or
(ii) a continuous pattern corresponding to removing a pattern of discrete spaced apart plates corresponding to the pattern of cuts from the metal layer; and
a second polymeric layer disposed on the second major surface of the functional layer.

15. The patterned article of claim 14 further comprising a substrate, the multilayer film disposed on, and substantially conforming to, at least a portion of the of a major surface of the substrate, the portion of the major surface being curved about two mutually orthogonal axes.
